(19) United States
(12) Patent Application Publication
(10) Pub. No.: US 2009/0208659 A1
(43) Pub. Date: Aug. 20, 2009

(54) METHOD AND APPARATUS IN CONNECTION WITH SPRAYING HEAD

(76) Inventor: Goran Sundholm, Tuusula (FI)

Correspondence Address: LADAS & PARRY LLP, 26 WEST 61ST STREET, NEW YORK, NY, 10023, US

(21) Appl. No.: 12/303,264

(22) PCT Filed: Jun. 27, 2007
(86) PCT No.: PCT/FI2007/050392

§ 371 Date: Dec. 3, 2008

(30) Foreign Application Priority Data
Jun. 27, 2006 (FI) 20060619

(51) Int. Cl. B05D 1/02; B05C 5/00

(52) U.S. Cl. 427/427.3; 118/323

(57) ABSTRACT

A method in connection with a spraying head, which spraying head comprises at least one nozzle (2) for spraying medium 5 and a protective element (3) which is in a protective position in front of the nozzle (2) and mechanically protects a possible triggering element (14) of the spraying head when the spraying head is in a non-10 active mode, and which protective element (3) is movable to a second position in which at least one nozzle (2) and the possible triggering element (14) are not protected by the protective element (3). A force effect 15 is directed in the protective element (3) by pressure medium from the effect of which the protective element (3) moves from the first position to the second position.

### BACKGROUND OF INVENTION

The invention relates to a method in connection with a spraying head according to the preamble of claim 1 which spraying head comprises at least one nozzle for spraying medium and a protective element which is in a protective position in front of the nozzle and mechanically protects a possible triggering element of the spraying head when the spraying head is in a non-active mode, and which protective element is movable to a second position in which at least one nozzle and the possible triggering means are not protected by the protective element.

The invention also relates to an apparatus according to claim 8.

Arrangements are known in connection with spraying heads, especially in connection with fire-extinguishing systems, in which a protective element is used as the protection of the spraying head which protective element is in the protective position in front of at least one nozzle of the spraying head and mechanically protects the nozzle and possibly also the triggering element when the spraying head is in the non-active position. The protective element is movable to the second position in which at least one nozzle and the possible triggering means are not protected with the protective element.

A spraying head, especially a sprinkler head, of this type especially intended for fire extinguishing is known e.g. from specification EP1150747. A protective element, such as a cup part, protecting the nozzles and the triggering element of the sprinkler head is released by a device which is movable in relation to the holder frame. The specification presents some different alternatives for releasing the protective element i.e. cup part and for bringing the sprinkler to the stand-by position. From specification U.S. Pat. No. 6,345,670 is known a spraying head which is provided with a protective element. In arrangements according to known prior art, pressure medium of an extinguishing system, typically extinguishing medium, has been used for releasing the protective element. Furthermore, different mechanisms for releasing the protective element of the spraying head have been used in the systems. These arrangements have required complex mechanical arrangements or possibly a special spraying head arranged for the purpose.

The spraying heads provided with a protective element in question are used in places where e.g. the surrounding conditions require protecting the spraying head. Typical locations are e.g. traffic tunnels. The conditions prevailing in the location of the spraying head can vary even considerably e.g. in relation to the temperature. Then, conditions can exist which impede the operation of the spraying head, such as a sprinkler head, and the release mechanism of its protective element. Such conditions can be e.g. varying weather conditions, such as moisture and temperature, or accumulated dirt.

The object of this invention is to achieve an arrangement by means of which many disadvantages caused by the surrounding conditions of the spraying head to the operation of the releasing mechanism of the spraying head and the protective element are avoided. Another object of the invention is to provide, inter alia, a combination excellent in reliability for a spraying head, especially for a sprinkler, and devices for releasing the protective cup of the sprinkler.

### BRIEF DESCRIPTION OF INVENTION

The invention is based on an idea in which the protective element of the spraying head is released by a separate pressure system.

It is characteristic of the method according to the invention that a force effect is directed in the protective element by pressure medium from the effect of which the protective element moves from the first position to the second position.

In addition, the method according to the invention is characterised by what is stated in claims 2-7.

It is characteristic of the apparatus according to the invention that the apparatus comprises pressure means for providing a force effect in the protective element of the spraying head so that the protective element moves from the first position to the second position.

The apparatus according to the invention is further characterised by what is stated in claims 9-12.

The arrangement according to the invention has numerous significant advantages. By arranging a separate pressure arrangement into connection with the spraying head, an extremely efficient and functionally sensible arrangement for releasing the protective element is provided. By using a pyrotechnical charge as the source of a pressure impulse, a versatile arrangement is provided which can be utilised, if required, also as a triggering element of the triggering means of the spraying head. For activating the pyrotechnical charge, it is possible to use in a way known per se an electronic impulse, whereby an extremely good connectivity to different control systems is provided. The invention enables arrangements in which protective elements can be moved from the first position to the second position individually and/or regionally. In the system, hose elements feeding pressure medium can be used as a coupling part of the protective element to prevent the harmful falling of the protective element. Then, there is no need for a separate fastening arrangement preventing the falling of the protective element. The arrangement is extremely applicable to be located in circumstances in which protecting the sprinkler head is necessary from, inter alia, the surrounding circumstances. Such are e.g. traffic tunnels. The arrangement is extremely applicable namely for fire-extinguishing applications and especially for applications in which liquid-bearing extinguishing medium, such as medium mist, is used as the extinguishing medium.

### BRIEF DESCRIPTION OF FIGURES

Next, the invention will be described in detail by means of an example with reference to the accompanying drawing in which

FIG. 1 shows an embodiment of an apparatus according to the invention,

FIG. 2 shows an embodiment of an apparatus according to the invention from direction A of FIG. 1,

FIG. 3 shows an embodiment of an apparatus according to the invention partially cut along line III-III of FIG. 1,

FIG. 4 shows an embodiment of an apparatus according to the invention,

FIG. 5 shows an embodiment of an apparatus according to the invention in a second position, and

FIG. 6 shows another embodiment of an apparatus according to the invention partially cut.

### DETAILED DESCRIPTION OF INVENTION

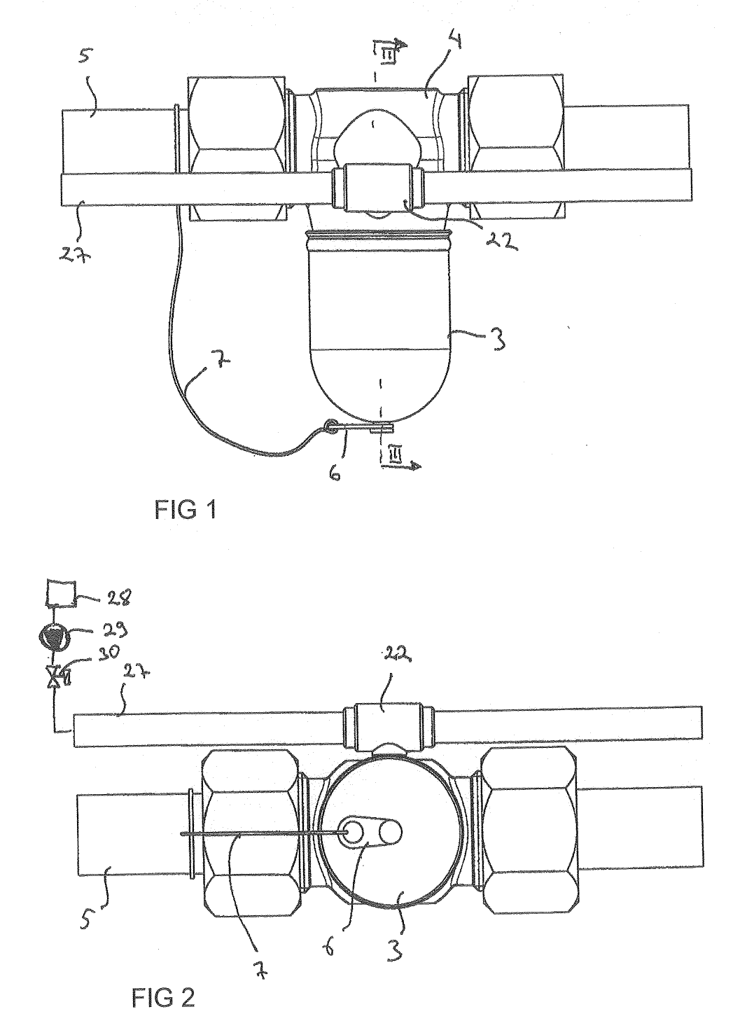

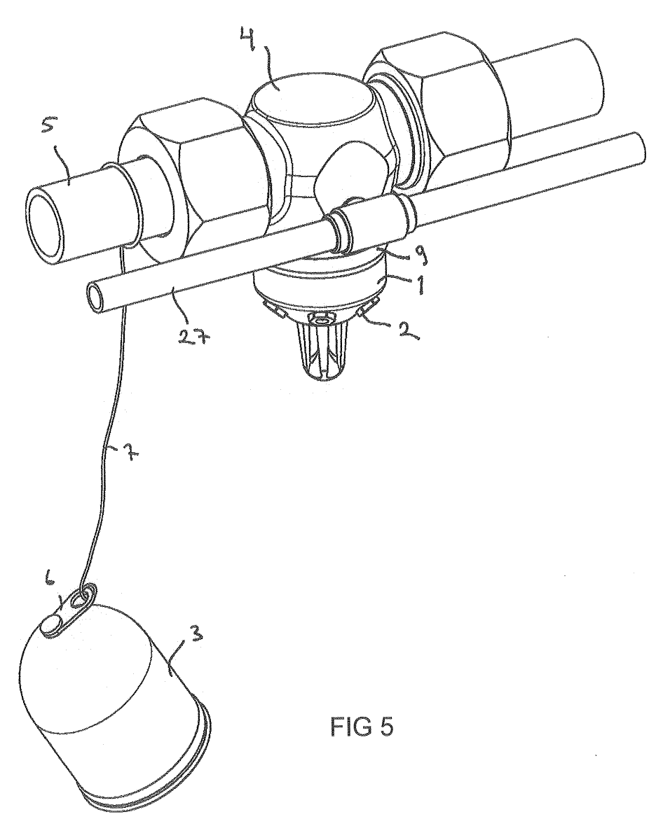

The figures show a spraying head applying a device according to the invention. The spraying head is arranged in a fastening part 4 joined into connection with a medium piping 5. Only a small part of the medium piping 5 is shown. A medium source, such as a tank, and means for conveying medium to the spraying head, especially a pump means, are not shown in the figures. In FIGS. 1, 2, 3, 4, the spraying head is shown when a protective element 3 in a first position. In FIG. 5, the protective element 3 is shown in a second position.

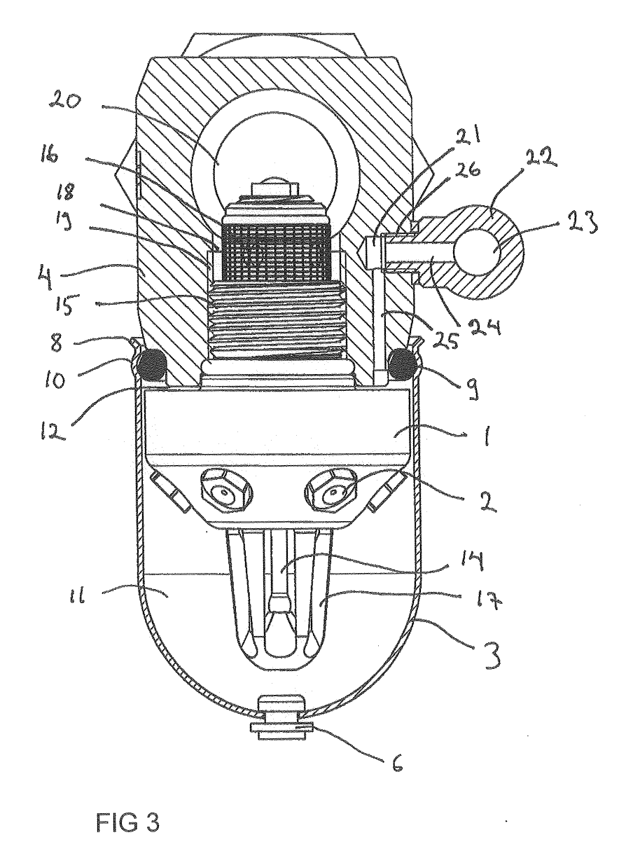

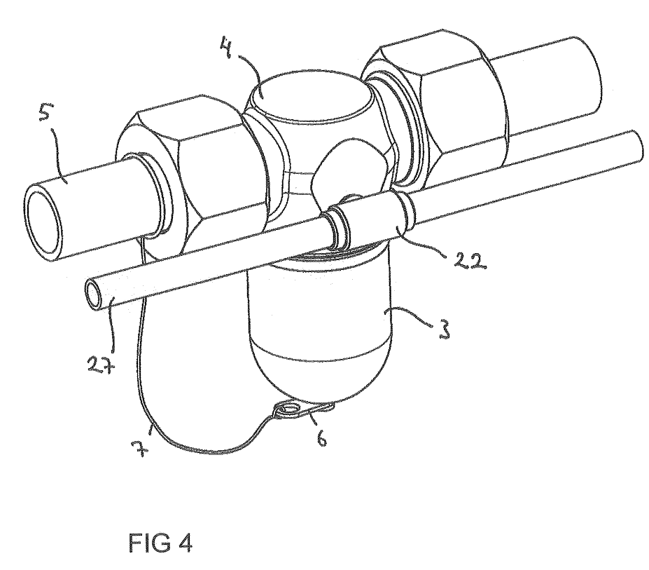

FIG. 3 shows an embodiment of an apparatus according to the invention partially cut. A frame 1 of the spraying head comprises at least one nozzle 2. In the figure, there are several nozzles 2 in the spraying head. Into connection with the spraying head is arranged the protective element 3 which protects at least one nozzle 2 from the effects of the surrounding conditions. Advantageously, the protective element 3 also protects a triggering means 14 possibly arranged in the spraying head, such as in the case according to the figure, when it is a case of a sprinkler head provided with a triggering device intended for fire-extinguishing use. Typically, the triggering means 14 can be e.g. an ampoule or equivalent reacting to heat which breaks after the temperature has exceeded a limit value set for the ampoule and releases a valve element of the spraying head to move into an open position in a way known per se.

The invention relates to a method in connection with a spraying head which spraying head comprises at least one nozzle 2 for spraying medium and a protective element 3 which is in a protective position in front of the nozzle 2 and mechanically protects a possible triggering element 14 of the spraying head when the spraying head is in a non-active mode, and which protective element 3 is movable to a second position in which at least one nozzle 2 and the possible triggering element 14 are not protected by the protective element 3. It is characteristic of the invention that a force effect is directed in the protective element 3 by pressure medium from the effect of which the protective element 3 moves from the first position to the second position.

According to an embodiment of the invention, the force effect is provided by conveying pressure medium into a space 11 a wall part of which is formed by the protective element 3.

According to an embodiment of the method according to the invention, a separate pressure medium system 27, 28, 29 is used for providing the force effect. The force effect is typically provided with a pressure system separate from the actual spraying system. FIG. 2 shows a pressure medium source 28, such as a tank, a possible pump device 29, a possible valve element 30 which can be joined to the control system of the system. When activated, the system provides an increase in pressure in a piping 27 from which there is a medium connection into a chamber, along a passage 23, 24, 25 of medium (FIG. 3). There is a joint part 22 which is fastened to a bore 21 made in the fastening piece 4 of the spraying head by means of threads 26 and corresponding counter threads. From the bore 21, there is a second bore 25 onto a surface 12 of the fastening piece 4 and into the chamber 11. An increase in pressure in the chamber 11 affects the protective element 3 so that it is detached from its locking and moves from the mode according to FIGS. 1-4 to the mode according to FIG. 5.

According to another embodiment, the passage of the pressure medium into the chamber 11 can be provided with a pipe/hose means through the wall of the protective element 3. Then, the hose means simultaneously operates as coupling means 6, 7 of the protective element 3 which prevent the harmful falling of the protective element

when the protective element 3 is in the second position.

The pressure medium is gas or liquid or a mixture of liquid and gas. According to an advantageous embodiment, the pressure medium is compressed air. The pressure medium source 28 can be e.g. a gas bottle the valve 30 of which is opened, whereby the pressure in the piping increases and the protective element 3 moves to the second position. Alternatively or in addition to the pressure medium source, it is possible to use the pump means 29, in connection with compressed air e.g. a compressor, which produces required pressure in the piping in order for the pressure in the chamber 11 to increase adequately so that the protective element 3 is detached from its locking and moves to the second position. Even though the pressure medium source 28 and the pump means 29 are connected in series in the figure, it is obvious to those skilled in the art that it is also possible to connect them in parallel.

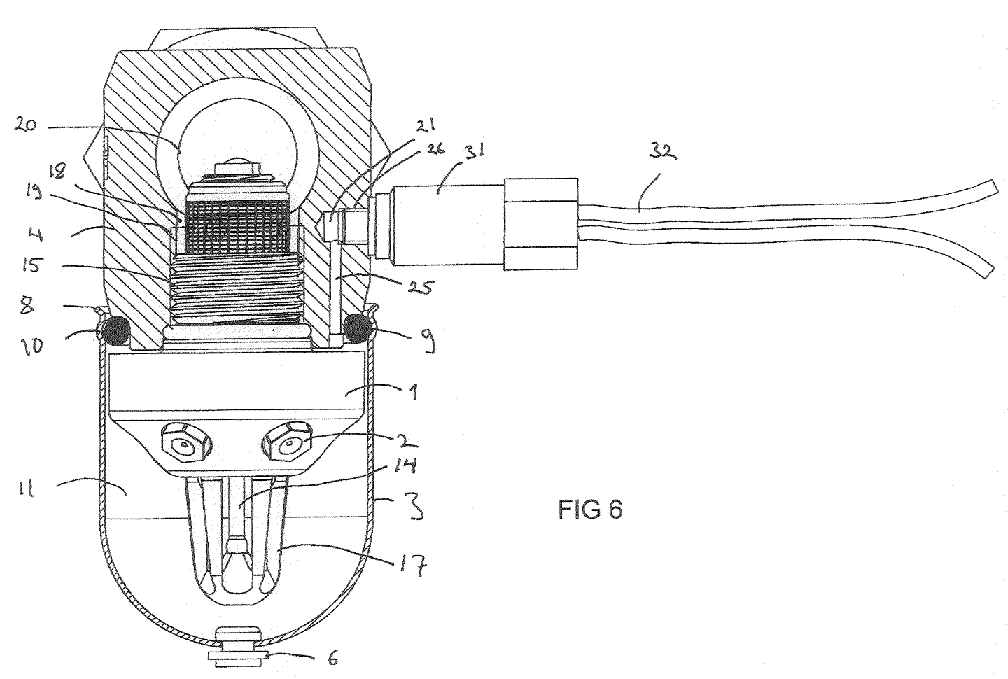

FIG. 6 shows an alternative embodiment of the invention according to which the force effect is provided with a pressure impulse achieved by a pyrotechnical charge 31. According to the figure, the pyrotechnical charge is fastened into the bore 21 formed in the fastening part 4 of the spraying head by means of the threads 26 and counter threads. From the fastening point, there is the medium passage 25 into the chamber space 11. The pyrotechnical charge comprises means 32 for triggering the pyrotechnical charge based on a control impulse. The figure shows part of guide elements 32 which convey the control impulse to the pyrotechnical charge. The pyrotechnical charge provides at least a pressure impulse as a result of which the protective element 3 moves from the first position to the second position. According to another embodiment, a thermal effect, which triggers the triggering means 14 of the spraying head, is also provided with the pyrotechnical charge 31. The pyrotechnical charge can e.g. when triggering make the temperature in the chamber space 11 increase higher than the triggering temperature set for the triggering means 14. Then, it is possible both to remove the protective element 3 and to trigger the spraying head by an impulse given by the control system. The control impulse is e.g. an electric impulse which is conveyed either with wires 32 or without wires to the pyrotechnical charge 31.

The invention also relates to an apparatus in connection with a spraying head which spraying head comprises at least one nozzle 2 for spraying medium and a protective element 3 which is in a protective position in front of the nozzle 2 and mechanically protects a possible triggering element 14 of the spraying head when the spraying head is in a non-active mode, and which protective element 3 is movable to a second position in which at least one nozzle 2 and the possible triggering element 14 are not protected by the protective element 3. The apparatus comprises pressure means 27, 28, 29; 31 for providing a force effect in the protective element 3 of the spraying head so that the protective element 3 moves from the first position to the second position.

The pressure means comprise the means 27, 28, 29 for conveying pressure medium into the chamber space 11 a wall part of which is formed by the protective element 3.

The pressure means for providing the force effect comprise according to another advantageous embodiment of the invention the pyrotechnical charge 31 which when triggered provides a pressure impulse in the chamber space 11, whereby the protective element moves from the first position to the second position.

The pyrotechnical charge 31 can also advantageously comprise means for triggering the triggering means 14 of the spraying head. Such can be e.g. means affecting the temperature of the chamber space 11 which increase the temperature of the chamber space as a result of the triggering of the pyrotechnical charge higher than the triggering temperature set for the triggering means of the spraying head.

The apparatus comprises according to an advantageous embodiment means for directing the pressure impulse to the chosen protective elements 3 in connection with the spraying heads. It is possible to use e.g. the valve elements 30 to open passages for the pressure medium only to devices in connection with desired spraying heads. There can be valves 30 e.g. in connection with each spraying head or in connection with regions comprising several spraying heads.

In the arrangement according to the embodiment of FIG. 6, the control impulse can be conveyed for each spraying head separately or to a region comprising several spraying heads.

In accordance with the embodiments according to the figures, the shape of the protective element 3 is cup-like. It is, however, possible that the shape of the protective element is something other. The shape is mostly dependent on the shape of the spraying head to be protected and its location.

It is possible that, in a system utilising the method and apparatus according to the invention, arrangements in accordance with shown embodiments can be used together with each other, whereby the system can include release arrangements of the protective element of the spraying head both provided with a pyrotechnical charge and operating by means of the pressure of a pressure medium network.

Next, the operation of the spraying head will be described in which the protective element is brought by means of the spraying head from the first position to the second position.

In the protective position, the protective element 3 extends to the frame 1 or its vicinity. An edge area 8 of the cup-like protective element 3 extends in the embodiment of FIG. 3 over the outer race of the frame 1 so far as a fastening part 9. The fastening part 9 can be e.g. an annular projection, such as a sealing element, for which there is on the inner surface of the protective element a counter element, such as an annular groove 10. In the case of the figure, the fastening part 9 of the protective element is arranged in the fastening part 4 of the spraying head 1.

At least one nozzle 2 is arranged in the frame part 1 of the sprinkler. There are several nozzles 2 in the sprinkler of the figure. To the sprinkler is arranged the triggering means 14, such as a heat-sensitive triggering means, e.g. an ampoule breaking at a certain temperature. The ampoule 14 is arranged between a support frame 17 in the lower part of the sprinkler frame 1 in FIG. 1 and a valve element of the sprinkler, i.e. valve stem, keeping the passage of the medium closed between an inlet and the nozzles 2 of the sprinkler at least in the non-active position and the standby position.

As a result of moving, the pressure medium affects the protective element 3. The protective element 3 detaches from the locked position (FIGS. 1, 2, 3, 4) and moves away from the front of the triggering means and the nozzles (FIG. 5).

The sprinkler comprises the sprinkler frame 1 in which there is at least one nozzle 2, the heat-activated triggering means 14 and the protective element 3 which is in the protective position in front of the nozzle 2 and mechanically protects the triggering element 14 when the sprinkler is in the non-active mode, and which protective element 3 is movable to the second position in which the nozzles 2 and the triggering means 14 are not protected by the protective element 3.

Thus, the spraying head, such as a sprinkler head, comprises the cup-like protective element 3 which protects the triggering means 14 and the nozzles 2. The protective element 3 is fastened in the arrangement according to FIG. 1 by means of the sealing element 9, most suitably an annular seal, in the protective position (FIG. 1). To the protective part 3 is formed the groove 10 for the annular seal 9. The groove 10 and the annular seal 9 of the protective part form a locking which keeps the protective part in its place in the protective position. Because of the ring seal 9, the protective element keeps well in its place in the protective position, whereby the vital parts of the sprinkler are well protected from the effects of the sprinkler surroundings. Such parts intended for protection are, inter alia, the triggering means 14, typically an ampoule, and the nozzles 2. The sprinkler can be placed in very different environments where it is exposed to impurities and dirtying which might impede the functioning of the sprinkler, inter alia, to cause malfunctions of the sprinkler without the protective element 3. Furthermore, the protective element 3 prevents the unwanted triggering of the triggering means 14 e.g. as a result of a short hot gas flow directed to the sprinkler. Such situations can occur, inter alia, in road tunnels where e.g. the exhaust gases of a lorry can momentarily be directed straight at the sprinkler.

In the arrangement according to the figure, in the protective element 3 is arranged the fastening element for the coupling part by means of which the harmful falling of the protective element 3 is prevented. The coupling part 7 is e.g. a banded part, such as a cord, wire or equivalent or a chain-like part. In the figure, the coupling part is fastened to the protective element 3 and from its other end to the pipe, whereby the detached protective element 3 remains hanging held by the coupling part 7.

In the standby mode (FIG. 5), the sprinkler can be activated in a usual way by means of the triggering means 14, e.g. when it has been broken as a result of heat, whereby the nozzles 2 can spray extinguishing medium.

The arrangement according to the invention is especially suitable for spraying liquid-bearing extinguishing medium mist. On applications and characteristics of the sprinkler, we refer e.g. to specifications EP1150747 and WO01/26742.

It is obvious to those skilled in the art that the invention is not limited to the embodiments described above, but it may be varied within the scope of the enclosed claims. When necessary, the features possibly described in this specification together with other features may also be used separately from each other.

1. A method in connection with a spraying head, which spraying head comprises at least one nozzle (2) for spraying medium and a protective element (3) which is in a protective position in front of the nozzle (2) and mechanically protects a possible triggering element (14) of the spraying head when the spraying head is in a non-active mode, and which protective element (3) is movable to a second position in which at least one nozzle (2) and the possible triggering element (14) are not protected by the protective element (3), characterised in that in the protective element (3) is directed by the pressure medium a force effect from the effect of which the protective element (3) moves from the first position to the second position.

2. A method according to claim 1, characterised in that the force effect is provided by conveying pressure medium into a space (11) a wall part of which is formed by the protective element (3).

3. A method according to claim 1, characterised in that a separate pressure medium system (27, 28, 29) is used for providing the force effect.

4. A method according to claim 1, characterised in that the force effect is provided with a pressure impulse achieved by a pyrotechnical charge (31).

5. A method according to claim 1, characterised in that the pressure medium is gas or liquid or a mixture of liquid and gas.

6. A method according to claim 1, characterised in that the pressure medium is compressed air.

7. A method according to claim 1, characterised in that with the pyrotechnical charge (31) is achieved also a thermal effect which triggers the triggering means (14) of the spraying head.

8. An apparatus in connection with a spraying head, which spraying head comprises at least one nozzle (2) for spraying medium and a protective element (3) which is in a protective position in front of the nozzle (2) and mechanically protects a possible triggering element (14) of the spraying head when the spraying head is in a non-active mode, and which protective element (3) is movable to a second position in which at least one nozzle (2) and the possible triggering element (14) are not protected by the protective element (3), characterised in that the apparatus comprises pressure means (27, 28, 29; 31) for achieving a force effect in the protective element (3) of the spraying head so that the protective element (3) moves from the first position to the second position.

9. An apparatus according to claim 8, characterised in that the means comprise the means (27, 28, 29) for conveying pressure medium into a chamber space (11) a wall part of which is formed by the protective element (3).

10. An apparatus according to claim 8, characterised in that the means for providing the force effect comprise a pyrotechnical charge (31) which when triggered provides a pressure impulse in the chamber space (11), whereby the protective element (3) moves from the first position to the second position.

11. An apparatus according to claim 8, characterised in that the pyrotechnical charge (31) comprises means for triggering the triggering means of the spraying head.

12. An apparatus according to claim 8, characterised in that the apparatus comprises means for directing the pressure impulse in the chosen protective elements (3) in connection with the spraying heads.
